(19) United States
(12) Patent Application Publication
(10) Pub. No.: US 2026/0140697 A1
(43) Pub. Date: May 21, 2026

(54) TECHNOLOGIES FOR SIMULTANEOUS EXTRACTION OF MINIMUM AND MAXIMUM VALUES FROM DATA STREAMS

(71) Applicant: SEMICONDUCTOR COMPONENTS INDUSTRIES, LLC, Scottsdale, AZ (US)

(72) Inventors: Joshua Charles BULLOCK, Reading (GB); Michael John LOCKEY, Alton (GB)

(73) Assignee: SEMICONDUCTOR COMPONENTS INDUSTRIES, LLC, Scottsdale, AZ (US)

(21) Appl. No.: 18/952,874

(22) Filed: Nov. 19, 2024

(51) Int. Cl. G06F 7/24; G06F 7/02

(52) U.S. Cl. CPC G06F 7/24; G06F 7/02

(57) ABSTRACT

The present technology includes outlier detection circuitry, which can be employed to filter out outlier values so that they do not negatively impact statistical analysis or processing tasks. The outlier detection circuitry can receive data as a stream of multiple sets with multiple values contained within one set. The outlier detection circuitry comprises dedicated hardware and/or software resources that determines the largest and smallest values that occur within each set in the received stream.

### BACKGROUND

There are many use cases where it is desirable to identify outlier values, such as the maximum and/or minimum values, from a dataset. These outlier values may be selected for sorting, selected for further processing, or discarded to avoid adversely affecting some other downstream process or application. For example, many data processing applications, such as filtering processes, data cleansing/cleaning processes, noise reduction processes, machine learning algorithms, image processing, signal processing, and the like, may require outlier values to be filtered out of a data set so that such outlier values do not have an adverse impact on statistical analysis. However, existing technologies for identifying outlier values may require storage of the data sets to be filtered or are otherwise unable to perform identification of such values on data streams. Other technologies for identifying outlier values may be capable of performing such identification on data streams, but are often too slow or complex for use in some applications.

### BRIEF SUMMARY

In order to effectively filter out outlying values so that they do not negatively impact statistical analysis or further processing tasks, outlier detection circuitry is employed. The outlier detection circuitry according to aspects of the present technology may receive data as a stream of multiple sets with multiple values contained within one set. The outlier detection circuitry comprises dedicated hardware and/or software resources that determines the largest and smallest values that occur within each set in the received stream. In some implementations, the outlier detection circuitry is capable of detecting and extracting up to, e.g., four (4) minimum values and up to four (4) maximum values from up to eight (8) input data elements received in parallel. The outlier detection circuitry is also capable of distinguishing between valid and invalid data inputs, as well as calculating both the minimum and maximum values in parallel using the same comparator hardware and/or software elements.

Some embodiments include a method of performing outlier detection. The method may include comparing, by outlier detection circuitry, a data input with a previous maxima value and a previous minima value of a previous data input. The method may include forming, by the outlier detection circuitry based on results of the comparing, at least one array. The method may include sorting, by the outlier detection circuitry, the at least one array based on one or more validity signals associated with the data input, the previous maxima value, and the previous minima value. The method may include extracting, by the outlier detection circuitry, at least one maxima value and at least one minima value from the sorted at least one array.

In some embodiments, the at least one array includes a maxima array, a minima array, or both a maxima array and a minima array.

In some embodiments, the data input comprises a first number of data elements, the previous maxima value comprises a second number of data elements, and the previous minima value comprises a third number of data elements. In some embodiments, the first number of data elements is equal to the second number of data elements, and/or the first number of data elements is equal to the third number of data elements. In other embodiments, a sum of the second and third number of data elements is equal to the first number of data elements.

In some embodiments, the one or more validity signals includes a set of data valid signals, a set of previous maxima valid signals, and a set of previous minima valid signals. Additionally or alternatively, a number of data valid signals in the set of data valid signals is the same as the first number of data elements, a number of previous maxima valid signals in the set of previous maxima valid signals is same as the second number of data elements, and/or a number of previous minima valid signals in the set of previous minima valid signals is same as the third number of data elements. Additionally or alternatively, respective data valid signals in the set of data valid indicate whether a corresponding data element in the data input is valid or invalid, respective previous maxima valid signals in the set of previous maxima valid signals indicate whether a corresponding data element in the previous maxima value is valid or invalid, and/or respective previous minima valid signals in the set of previous minima valid signals indicate whether a corresponding data element in the previous minima value is valid or invalid.

In some embodiments, the at least one array comprises a maxima array, and forming the at least one array comprises forming a first portion of the maxima array using the results of the comparing; and forming a second portion of the maxima array based on a transpose of the first portion. In some embodiments, the maxima array is a two dimensional array, and forming the maxima array comprises forming the first portion such that a number of stored elements progressively decreases with each subsequent row in the maxima array; and forming the second portion such that a number of stored elements progressively increases with each successive row in the maxima array. In some embodiments, forming the maxima array further comprises storing a predefined value in a leading diagonal of elements in the maxima array. In some examples, the predefined value is 1. In some embodiments, the at least one array further comprises a minima array, and forming the at least one array comprises forming the minima array by transposing the maxima array.

In some embodiments, each column in the at least one array corresponds to a respective data element in a set of data elements. The set of data elements includes at least one data element from the data input, at least one data element from the previous maxima value, and at least one data element from the previous minima value.

In some embodiments, comparing the data input with the previous maxima value and the previous minima value comprises comparing an initial data element from the set of data elements against every other data element in the set of data elements; and comparing each other data element in the set of data elements against every other data element in the set of data elements that has not been selected or compared until all data elements in the set of data elements have been compared.

In some embodiments, each row in the at least one array corresponds to a respective data element in the set of data elements. In some embodiments, sorting the at least one array comprises identifying, according to the one or more validity signals, valid data elements in the set of data elements and invalid data elements in the set of data elements; populating each cell in each column corresponding to an invalid data element with a first value; and iterating over each row in each column corresponding to a valid data element. In some examples, the first value is 0.

In some embodiments, iterating over each row in each column corresponding to a valid data element comprises determining whether a data element corresponding to a row index of a valid row is valid and whether a value at a cell defined by the row index and a column index of a valid column is equal to a second value; and when the element is valid and the value is the second value, filling a lowest unfilled row in the corresponding column of the at least one array with the second value. In some examples, the second value is 1.

In some embodiments, iterating over each row in each column corresponding to a valid data element comprises: for each row corresponding to a valid data element, identifying each array element in each column corresponding to a valid data element that is equal to a second value; and for each identified array element, populating a lowest array element in each row storing the first value with the second value. In some examples, the second value is 1.

In some embodiments, extracting the at least one maxima value and the at least one minima value from the sorted at least one array comprises, for each column corresponding to a valid data element, performing a binary right shift operation on a column value; inverting the right shifted column value; and performing a binary AND operation on the column value and the inverted column value. In some examples, the column value is a binary number defined by each element in the column.

In some examples, the extracting the at least one maxima value from the sorted at least one array comprises determining, as the at least one maxima value, a data value corresponding to a column with a lowest row in the at least one array storing the second value. In some examples, the extracting the at least one minima value from the sorted at least one array comprises determining, as the at least one minima value, a data value corresponding to a column with a highest row in the at least one array storing the second value.

Some embodiments include an outlier detection circuit. The outlier detection circuit may include comparator circuitry configured to compare a data input with a previous maxima value and a previous minima value of a previous data input. The outlier detection circuit may include array forming circuitry configured to form at least one array based on results of the comparison of the comparator circuitry. The outlier detection circuit may include array sorting circuitry configured to sort the at least one array according to one or more validity signals. The outlier detection circuit may include extractor circuitry configured to extract at least one maxima value and at least one minimum value from the sorted at least one array.

In some embodiments, the comparator circuitry comprises an array of comparators arranged such that no comparison of data elements of the data input with the previous maxima value and the previous minima value is repeated.

In some embodiments, the at least one array comprises a maxima array, and the array forming circuitry is configured to: form a first portion of the maxima array using the results of the comparing; and form a second portion of the maxima array based on a transpose of the first portion.

In some embodiments, the maxima array is a two dimensional array, and the array forming circuitry is configured to: form the first portion such that a number of stored elements progressively decreases with each subsequent row in the maxima array; and form the second portion such that a number of stored elements progressively increases with each successive row in the maxima array.

In some embodiments, the array forming circuitry is configured to: store a predefined value in a leading diagonal of elements in the maxima array. In some examples, the predefined value is a 1.

In some embodiments, the at least one array further comprises a minima array, and the array forming circuitry is configured to: form the minima array by transposing the maxima array.

In some embodiments, each column in the at least one array corresponds to a respective data element in a set of data elements, and the set of data elements includes at least one data element from the data input, at least one data element from the previous maxima value, and at least one data element from the previous minima value.

In some embodiments, the comparator circuitry is configured to: compare an initial data element from the set of data elements against every other data element in the set of data elements; and compare each other data element in the set of data elements against every other data element in the set of data elements that has not been selected or compared until all data elements in the set of data elements have been compared.

In some embodiments, each row in the at least one array corresponds to a respective data element in the set of data elements, and the array sorting circuitry is configured to: identify, according to the one or more validity signals, valid data elements in the set of data elements and invalid data elements in the set of data elements; populate each cell in each column corresponding to an invalid data element with a first value; and iterate over each row in each column corresponding to a valid data element. In some examples, the first value is 0.

In some embodiments, the array sorting circuitry is configured to iterate over each row in each column corresponding to a valid data element including: for each row corresponding to a valid data element, identify each array element in each column corresponding to a valid data element that is equal to a second value; and for each identified array element, populate a lowest array element in each row storing the first value with the second value. In some examples, the second value is 1.

In some embodiments, the extractor circuitry is configured to: for each column corresponding to a valid data element, perform a binary right shift operation on a column value, wherein the column value is a binary number defined by each element in the column; invert the right shifted column value; and perform a binary AND operation on the column value and the inverted column value.

In some embodiments, the extractor circuitry is configured to: determine, as the at least one maxima value, a data value corresponding to a column with a lowest row in the at least one array storing the second value; and determine, as the at least one minima value, a data value corresponding to a column with a highest row in the at least one array storing the second value.

### BRIEF DESCRIPTION OF THE DRAWINGS

FIG. 1 illustrates an exemplary system in which aspects of the technology can be practiced.

FIG. 2 illustrates an exemplary imaging system in accordance with aspects of the technology.

FIG. 3 illustrates an example scenario in accordance with aspects of the technology.

FIG. 4 illustrates an example pixel array and readout assembly for an image sensor in accordance with aspects of the technology.

FIG. 5 illustrates components of an example outlier detector in accordance with aspects of the technology.

FIG. 6 illustrates example operations for forming maxima and minima arrays detector in accordance with aspects of the technology.

FIG. 7 illustrates an example comparison results table in accordance with aspects of the technology.

FIG. 8 illustrates an example maxima array based on the comparison results of FIG. 7.

FIG. 9 illustrates an example of a minima array based on the comparison results of FIG. 7 and/or the maxima array of FIG. 8.

FIG. 10 illustrates an example sorted maxima table based on the maxima array of FIG. 8.

FIG. 11 illustrates an example sorted minima table based on the minima array of FIG. 9.

FIG. 12 illustrates an example extracted maxima table based on the sorted maxima table of FIG. 10.

FIG. 13 illustrates an example extracted minima table based on the sorted minima table of FIG. 11.

FIG. 14 illustrates an example maxima selection table for selecting a maxima and an example minima selection table for selecting a minima in accordance with aspects of the technology.

FIG. 15 illustrates an example method in accordance with aspects of the technology.

### DETAILED DESCRIPTION

As noted above, outlier detection can be used filter out outlying values so that they do not negatively impact statistical analysis or further processing tasks. This may be particularly beneficial in image sensing, although the technology may be employed in numerous other applications, including other types of sensors that receive real-time data streams. Image sensors and imaging systems are used in a wide variety of electronic devices to capture imagery for many different situations and applications. In a typical arrangement, an image sensor has an array of image pixels arranged in rows and columns. Readout circuitry can be coupled to a corresponding column for reading out image signals from each of the image pixels in that corresponding column.

Large image pixel arrays may be particularly suitable for situations where high-resolution imagery is needed. However, issues can arise when trying to perform readout operations. For instance, there may be hundreds or thousands of rows and columns in the array. The frame rate for pixel readout is proportional to the time it takes to read out all of the rows in the array. For instance, doubling the number of rows would halve the frame rate if all other factors remain constant. A faster readout by the imaging system may necessitate higher power consumption by the imaging system. Moreover, being able to discard outlier values can be very helpful, for instance to reduce artifacts.

### 1. Example Systems and Implementations

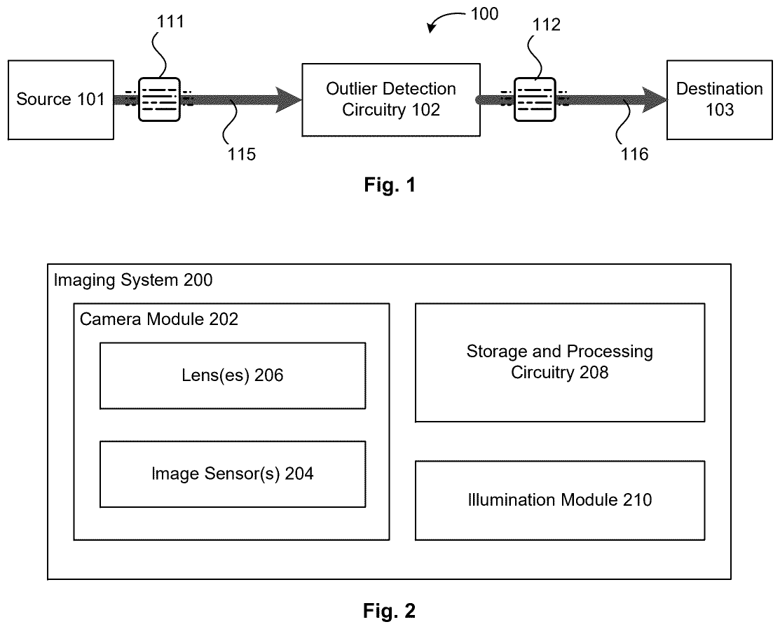

FIG. 1 illustrates example logical interactions between elements of a system 100. As shown, the system 100 includes a source node 101, outlier detection circuitry (ODC) 102, and a destination node 103. The source 101 and/or destination 103 may be any type of system, device, platform, component, application (app), service, or other entity or element. In some embodiments, the system 100 may represent an individual computing system or device where each of source 101, ODC 102, and destination 103 are individual components. In other embodiments, the system 100 may represent a network or other interconnection of computing systems or devices, where at least the source 101 and destination 103 are separate systems or devices, and potentially ODC 102 is implemented separately from the source 101 and/or destination 103. Examples of such systems or devices can include imaging devices, mobile phones, smartphones, tablet computers, wearable devices (e.g., smart watch, fitness tracker, smart glasses, smart clothing/fabrics, head-mounted displays, and/or the like), laptop computers, desktop computers, workstations, in-vehicle infotainment systems, head-up display (HUD) devices, an extended reality (XR) system (e.g., including augmented reality (AR), virtual reality (VR), mixed/mediated reality (MR) technologies), video game consoles, engine management systems, engine control units, embedded systems, microcontrollers, control modules, networked appliances and/or network elements (e.g., base stations, routers, hubs, switches, fabrics, gateways, network functions, and/or the like), satellites, sensors, Internet of Things (IoT) devices, smart appliances, autonomous or semi-autonomous drones (e.g., unmanned terrestrial/ground vehicle systems, unmanned surface/aquatic vehicle systems, unmanned aerial vehicle (UAV) systems, and/or the like), robots, electronic signage, single-board computers, plug computers or dongles, and/or any type of computing device, such as any of those discussed herein. Additionally or alternatively, the source 101, ODC 102, and/or destination 103 may be implemented as part of imaging system 200 discussed infra.

As mentioned previously, in some embodiments, the source 101 and destination 103 may be implemented as components or parts of the same system or device. Additionally or alternatively, the source 101 and destination 103 may be different apps or software elements operated by the same or different systems. In a first example, the source 101 is a first app operated by a system and the destination 103 is a second app operated by the same system. In a second example, the source 101 is an app operated by a system and the destination 103 is a memory location, buffer, register, or a directory/path of a file system operated by the system. In a third example, the source 101 is a first memory buffer and the destination 103 is the same or different memory buffer. In a fourth example, the source 101 is a sensor and the destination 103 is an on-board processor or an on-board memory chip implemented by the sensor.

In other embodiments, the source 101 and destination 103 are implemented as, or by, separate systems. In a first example, the source 101 is an IoT device, such as a sensor (e.g., an image sensor), and the destination 103 is a system or computing service remote from the IoT device that processes and/or stores data generated by IoT devices/sensors. In a second example, the source 101 is a first network node in a network and the destination 103 is a second network node in the same or different network. In this example, the network may be a wireless network such as a wireless local area network (WLAN) or cellular network, or the network may be a wired network, such as a data center network or the like. Additionally, the network nodes may be user equipment, base stations, switches, routers, bridges, hubs, gateways, network functions, and/or any other type of device/system that participates in one or more networks.

In the example of FIG. 1, the source 101 may be configured to send data 111 to the destination 103. The data 111 can be produced as a result of one or more processes, measurements, or other phenomena. For example, the data 111 may represent a raw signal or processed data generated by a sensor (e.g., an image frame or other image-related signal). In another example, the data 111 may represent signaling or a collection of data elements, such as one or more data packets, protocol data units (PDUs), frames, segments, and/or the like, produced by a communication device. The data 111 may represent other types of analog or digital signals and/or various collections of data. In some examples, the data 111 is or includes a set of data points or elements, and therefore, data 111 may be referred to as data set 111 (or “dataset 111”). It should be noted that the dataset 111 may be a sample that is part of a population or a larger dataset. Furthermore, the data 111 may be in any suitable form, format, or data structure. For example, the form, format, or data structure of data 111 may be based on requirements of the medium 115, such as those specified in a relevant communications protocol, data exchange format, interface definition language (IDL), and/or other aspects of medium 115. In some examples, the data 111 may be streamed from the source 101 towards the destination 103. Here, the data 111 (or “data stream 111”) may be a sequence of data elements made available over time, or a continuous or quasi-continuous flow of data.

The ODC 102 may operate as a filter, and may comprise hardware and/or software elements that process a data structure or dataset to produce another data structure, dataset, or data subset; process a data stream to produce another data stream; process stored and/or streaming data according to one or more conditions, criteria, rules, policies, and/or the like; and/or process a stream or signal to remove some unwanted or undesirable components, features, or other aspects from the stream or signal. In some embodiments, the ODC 102 may be implemented by the source 101, the destination 103, or a system comprising both the source 101 and destination 103. In other embodiments, the ODC 102 may be implemented by an entity separate from the source 101 and/or the destination 103. In either of these embodiments, the source 101 and the destination 103 may be separate systems.

In the example of FIG. 1, the source 101 sends the data 111 to ODC 102 over a medium 115. In embodiments where the source 101 and ODC 102 are implemented by the same system, the medium 115 may be a software connector, software glue, middleware, API, ABI, driver(s), and/or any other means of communication between apps and/or services. Where a system is processing data locally, the medium 115 could represent one or more memory buffers, a file system or directory, and/or the like. In embodiments where the source 101 and ODC 102 are implemented by different systems, the medium 115 may be any suitable wired or wireless communication interface and/or protocol.

The ODC 102 receives the dataset 111, performs various operations on the dataset 111 to detect one or more outlier values according to the various embodiments and examples discussed herein, and generates dataset 112. The dataset 112 is then conveyed to the destination 103 over medium 116. The medium 116 may be the same or different than the medium 115. For example, the medium 116 may include any means of interconnection and/or communication, or combinations thereof, between apps, services, components, devices, systems, and/or networks.

Similar to the data 111, the data 112 may be a sequence of data, such as a data stream or data flow, or the data 112 may be a collection or package of data elements, such as one or more data packets, PDUs, frames, segments, and/or the like. For example, the form/format of the data 112 may be based on requirements of the medium 116 over which is to be conveyed, such as those specified in a relevant communications protocol, data exchange format, IDL, and/or other aspects of medium 116. In some embodiments, a separate encoder (not shown by FIG. 1) may be used to package the dataset 112 for conveyance over the medium 116. In some implementations, the dataset 112 has the same form, format, or structure as the dataset 111, albeit without the one or more outlier values (or only with the one or more outlier values). In other implementations, dataset 112 may have a different form, format, or structure than dataset 111. In any of the embodiments discussed herein, the dataset 111 and/or dataset 112 may be any form of human-readable and/or machine-readable data.

As alluded to previously, some of the data points/elements of the dataset 111 may be outlier values. Outlier values (or simply “outliers”) may refer to elements or data points in a dataset 111 that differ from other elements or data points in the dataset 111 in some significant way. Outliers can arise due to variability in the data 111, variability in measurement, or can be a result of some error or fault in the data 111, such as measurement error, translation error, transmission error, and/or the like. In some data samples, some data points may be further away from the sample mean than what is deemed reasonable. Outliers, often being the most extreme observations, may include a sample maximum and/or a sample minimum depending on whether they are extremely high or low.

Outliers can skew and mislead the results, and therefore, detecting and handling outliers is useful for accurate data processing and interpretation. Therefore, one or more outlier values may need to be identified and/or removed from the data 111 before being passed to the destination 103. In this regard, the data 111 may be passed or fed to ODC 102 prior to being transmitted to the intended destination 103. As noted above, the ODC 102 is an intermediary element between the source 101 and destination 103 that identifies outliers from the dataset 111 and produces dataset 112 based on the identification of the outliers. In some implementations, the ODC 102 removes the outliers from dataset 111, and thus, in such implementations the dataset 112 has fewer (or no) skewed data points. In other implementations, the ODC 102 removes the non-outlier values from dataset 111, and thus, in such implementations the dataset 112 only includes the outliers. In other implementations, the ODC 102 locates outlier values without deleting those values. The following examples are described where the ODC 102 removes the outliers from the dataset 111, such that the dataset 112 does not include the outliers. Although the following discussion provides an example of discarding or otherwise removing outliers from dataset 111, other implementations and/or use cases are also possible according to the various embodiments discussed herein.

FIG. 2 shows an exemplary imaging system 200, such as an electronic device that employs sensor circuitry (also referred to as a sensor module) to capture imagery, which may employ ODC 102 to remove outliers (e.g., outlier pixel or other image information) from its datasets (e.g., from captured image frames). Imaging system 200 may comprise or be part of a still or video camera, a webcam, a video surveillance system, a high speed inspection system, a vehicle imaging system, a video game system with imaging capabilities, an XR system, robot, drone, a commercial or industrial system, satellite imaging systems, and/or any other imaging-based system or application, including any of the systems mentioned herein. Camera (or imaging) module 202 is configured to convert incoming/received light into digital image data. Camera module 202 includes one or more image sensors (or sensor modules) 204.

During an image capture process, light (visible and/or non-visible) from a scene is focused onto the image sensor(s) 204 by one or more corresponding lenses 206. Image sensors 204 may include circuitry for generating analog pixel image signals and circuitry for converting those image signals into corresponding digital image data. The digital image data may be provided to storage and processing circuitry 208.

Storage and processing circuitry 208 may include, for example, one or more integrated circuits (ICs), such as image processing circuits, microprocessors, storage devices such as random-access memory (RAM) and/or non-volatile memory (NVM), and/or the like. This circuitry may be implemented using components that are separate from camera module 202 or that may form part of camera module 202. When storage and processing circuitry 208 is implemented on different ICs than those implementing camera module 202, the ICs with circuitry 208 may be stacked or otherwise packaged with the ICs for camera module 202. In some implementations, the storage and processing circuitry 208 may include one or more central processing units (CPUs) or individual processor cores, one or more graphics processing units (GPUs), one or more accelerated processing units (APUs), one or more neural processing units (NPUs), one or more tensor processing units (TPUs), one or more microcontrollers, one or more application-specific integrated circuits (ASIC), one or more field-programmable gate arrays (FPGAs), one or more digital signal processors (DSPs), and/or other hardware-based processing elements. References to a processor should be understood to include references to a single processor or a collection of processors that may or may not operate in parallel.

Image data that has been captured by camera module 202 may be processed and stored using processing circuitry 208 (e.g., using an image processing engine of processing circuitry 208, using an imaging mode selection engine on processing circuitry 208, etc.). Processed image data may be provided to external equipment such as a computer, a vehicle control system, an external display, and/or other devices using a wired or wireless communications path coupled to processing circuitry 208 (not shown).

In the example of FIG. 2, camera module 202 can include illumination module 210, which is configured to emit light for illuminating objects in an image scene. Image sensor(s) 204 may be configured to gather reflected versions of the emitted light and to generate image information for the scene. By way of example only, such image information may include depth or distance information for one or more objects, a depth or distance map of the image scene, an image of the image scene, etc.

Illumination module 210, such as a light emitter controlled by the driver circuitry, may emit light having any suitable characteristic(s). This can include any suitable waveform, peak amplitude or power, periodicity or frequency, pulses of light, light with a modulated amplitude and a modulation frequency, etc. The emitted light may be in the infrared (IR) and/or optical bands, and may be generated by an LED or a laser configured to emit one or more light pulses, such as in a light pulse train. The emitted light may reach one or more objects in an image scene and reflect off of such objects, returning to the camera module 202 as reflected light. Objects may include any suitable objects, whether fixed or mobile. By way of example only, in a driving scene for a vehicle operating in an autonomous (or manual) driving mode, objects may include signage, street light, driving or bike lanes, curbs or sidewalks, other road users (e.g., other vehicles, bicyclists or pedestrians), trees or shrubbery, and the like.

Reflected light may be received at the image sensor 204 (e.g., at one or more active image pixels, at one or more photosensitive elements in the active image pixels, etc.). Driver circuitry and/or control circuitry may control the pixels to generate one or more image frames based on the reflected light, such as by providing control signals coupled to transistors or other actuated elements (e.g., switching elements) in the pixels. In particular, based on the received control signals from the driver circuitry and/or control circuitry, the pixels may generate different portions of charge in response to reflected light (e.g., during an integration or exposure time period), may perform one or more readout operations on the generated portions of charge (e.g., during a readout time period), or may perform other operations during other time periods.

Processing circuitry in camera module 202 (or processing circuitry 208 in the imaging system 200) may control illumination module 110 (if employed) and know the characteristics of the emitted light signal. The processing circuitry may control the image sensor(s) 204 to generate image signals for one or multiple image frames, which are indicative of the characteristics of the reflected light signal. The system may process (e.g., compare and correlate) the generated image signals for these image frames to the reflected light and to emitted light to determine a phase difference and/or time of flight information. Moreover, the processing circuitry may implement ODC 102.

According to various aspects of the present technology, the ODC 102 may be implemented or deployed in different parts or areas of the imaging sensor 200. In one implementation, the ODC 102 may be part of the image sensor circuitry 204. In another implementation, the ODC 102 may be part of the storage and processing circuitry 208. In another implementation, the ODC 102 may be a separate, standalone component that is connected to the image sensor(s) 204 and the storage and processing circuitry 208 via a suitable interconnect technology. In any of the aforementioned implementations, the ODC 102 may act as a filter or other intermediary between the image sensor circuitry 204 and the storage and processing circuitry s208.

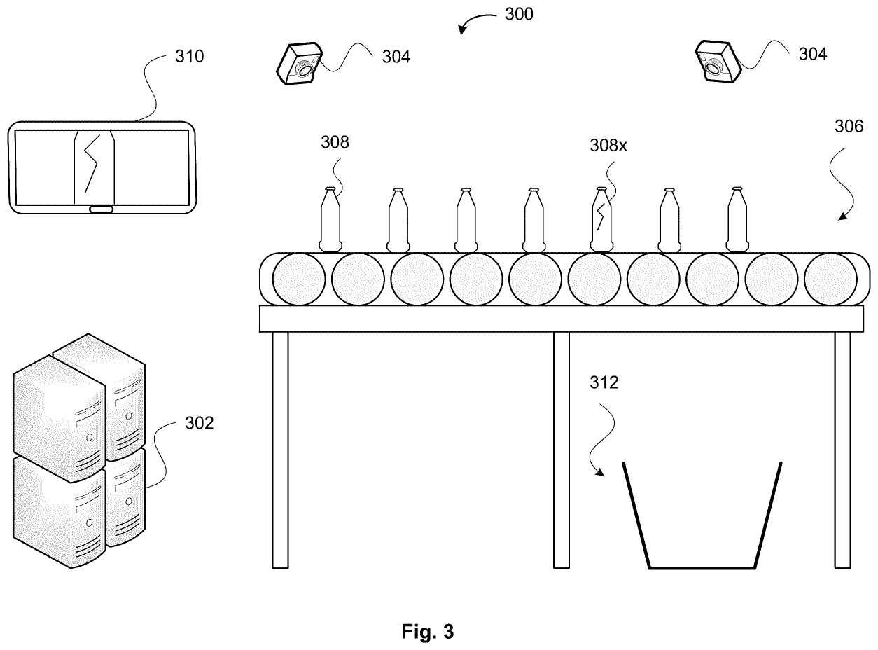

FIG. 3 illustrates an exemplary image sensing scenario 300, where a set of image sensors are part of an automated inspection system. In particular, the inspection system in this example includes a processing system 302 operatively coupled to image sensors 304. The image sensors 304 are configured to obtain imagery along an inspection line 306 (e.g., an assembly line in a factory or other production facility, a waste stream in a material recovery facility, and/or the like) or other inspection setup. As shown, a number of items, such as bottles 308, move along the inspection line 306. A display 310 may present imagery captured by the image sensors 304. One of the items, in particular bottle 308x, is shown to have a crack or other defect, as displayed on display 310. As part of an automated inspection process, this defective item may be discarded into bin 312. In other situations, any defective items may be flagged or otherwise identified for further testing or repair.

In this image sensing scenario 300, sensors 304 may produce imagery, which is then provided to the processing system 302 for defect detection. The imagery produced by the sensors 304 may be in the form of a streaming image array or other set of pixel values. The ODC 102 may be employed at individual sensors 304 and/or at the processing system 302 to detect outliers in captured image data. In some examples, the ODC 102 receives a set of eight pixels simultaneously, not all of which might be valid due to the way that they are read out from the image sensor. The four largest values and the four smallest values, or up to the four largest and up to the four smallest values, may be removed from that stream so that the pixel values without the outliers can be used for further statistical analysis, such as the defect detection. One goal is to remove the outliers as quickly as possible so as to avoid storing such data prior to processing by the processing system 302.

One way invalid data may come about may be due to different clocking frequencies, for example, where a first frequency is used for reading out the image array and a second frequency is used for processing the image array after being read out. For instance, the first frequency may be employed by the sensors 304 and the second frequency may be employed by the processing systems 302. The processing frequency may be different than the read frequency in order to process more data elements per clock cycle. However, this may result in some of the data elements not actually being valid due to additional data elements being added to the image array around the beginning and end of the relevant section of the image array being processed. Another way in which invalid data may come about is due to misalignment between the readout image array and a starting point for processing the image array, which may result in some invalid data values being obtained before valid values are obtained.

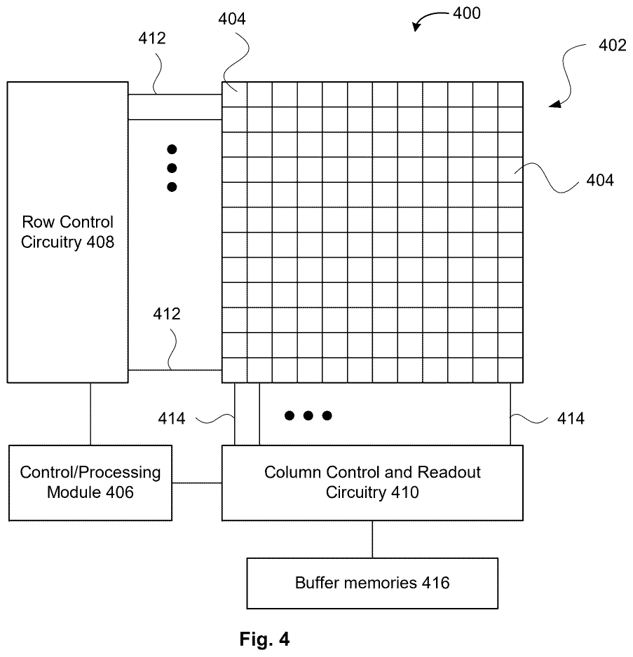

FIG. 4 illustrates an example configuration of a pixel array and readout assembly 400 for the image sensor 204 of FIG. 2. As shown in FIG. 4, the assembly 400 includes a pixel array 402 containing sensor pixels 404 arranged in rows and columns, along with control and processing circuitry in module 406. The array 402 may contain, for example, tens, hundreds, or thousands of rows and columns of sensor pixels 404. Module 406 may be coupled to row control circuitry 408 (sometimes referred to as row driver circuitry or pixel driver circuitry) and column control and readout circuitry 410 (sometimes referred to as column readout circuitry or column control circuitry, readout circuitry, or column decoder circuitry). Control module 406 may receive (row) addresses from row control circuitry 408 and supply corresponding (row) control signals such as reset, anti-blooming, row select (or pixel select), modulation, storage, charge transfer, readout, sample-and-hold, and/or store control signals to pixels 404 over (row) control paths 412.

One or more lines such as column lines 414 may be coupled to each column of pixels 404 in array 402. Column lines 414 may be used for reading out image signals from pixels 404 and for supplying bias signals (e.g., bias currents or bias voltages) to pixels 404. The column control and readout circuitry 410 may receive image signals (e.g., analog pixel values generated by pixels 404) over lines 414. This circuitry 410 may include memory circuitry for storing calibration signals (e.g., reset level signals, reference level signals) and/or image signals (e.g., image level signals) read out from the array 402, amplifier circuitry or a multiplier circuit, analog to digital conversion (ADC) circuitry, bias circuitry, latch circuitry for selectively enabling or disabling the portions (columns) of the circuitry 410, or other circuitry that is coupled to one or more pixels in array 402 for operating pixels 404 and for reading out image signals from pixels 404. ADC circuitry in the circuitry 410 may convert analog pixel values received from array 402 into corresponding digital pixel values (sometimes referred to as digital image data or digital pixel data). The circuitry 410 may supply digital pixel data to control/processing module 406 for pixels 404 (e.g., in one or more pixel columns).

The pixel array 402 may also be provided with a filter array having multiple (color) filter elements each corresponding to a respective pixel, which allows a single image sensor to sample light of different colors or sets of wavelengths. In general, filter elements of any desired color and/or wavelength (e.g., optical or infrared wavelengths) and in any desired pattern may be formed over any desired number of image pixels 404. By way of example, for time-of-flight sensing using an illumination source (e.g., in illumination module 110 in FIG. 2), the pixel array 402 may be provided with a correspond filter array that passes light having colors and/or frequencies emitted from the illumination source.

A set of buffer memories 416 (e.g., RAM and/or the like) may be coupled to the column control and readout circuitry 410. As shown, buffer memories 416 is coupled to the column control and readout circuitry 410. As discussed further below, the buffer memories 416 is/are employed when performing parallel row readout.

The image sensors 204 of camera module 202 (see FIG. 2) may include one or more arrays 402 of image pixels 404. The image pixels 404 may be formed in a semiconductor substrate using complementary metal-oxide-semiconductor (CMOS) technology, charge-coupled device (CCD) technology, or any other suitable photosensitive device technology. Image pixels 404 may be frontside illumination (FSI) image pixels or backside illumination (BSI) image pixels. Moreover, the array 402 may include pixels 404 of different types such as active pixels, non-active pixels, optically shielded pixels, reference pixels, etc. If desired, the image sensor(s) may include an integrated circuit package or other structure in which multiple integrated circuit substrate layers (e.g., from multiple wafers) or chips are vertically stacked or otherwise arranged with respect to each other.

### 2. Data Point Outlier Detection Aspects

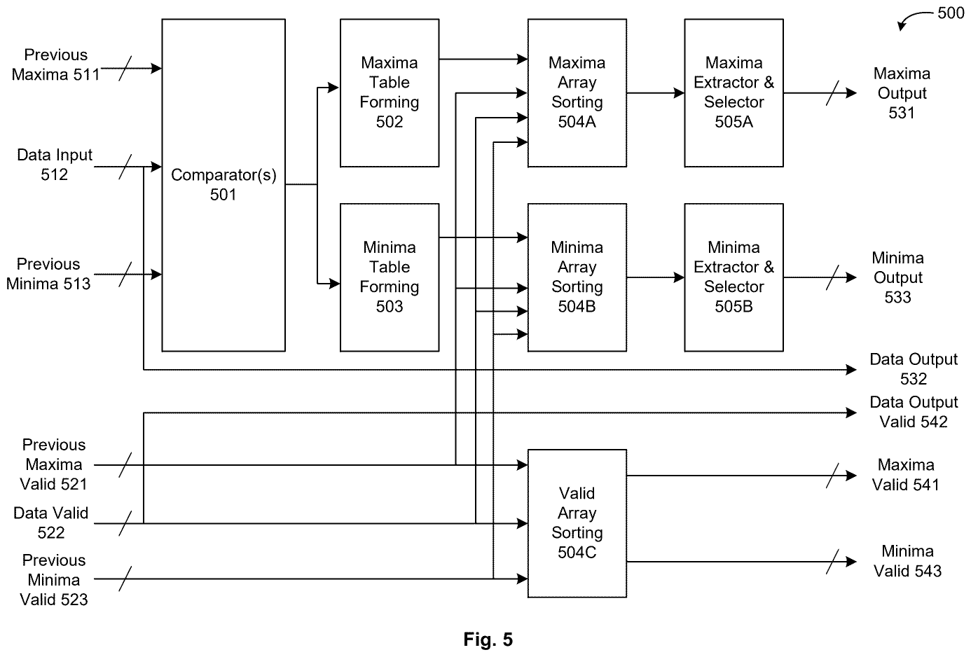

FIG. 5 illustrates an example outlier detector 500 (also referred to as “filter 500”) according to aspects of the technology. In some implementations, the outlier detector 500 may correspond to the ODC 102 in FIG. 1. In this example, the outlier detector 500 includes one or more comparators 501, a maxima array forming element 502, a minima array forming element 503, maxima array sorting element 504A, minima array sorting element 504B, valid array sorting element 504C, maxima extractor and selector 505A, and minima extractor and selector 505B. Each of these elements may be implemented using any combination of hardware elements (e.g., logic gates, programmable logic devices, FPGAs, ASICS, and/or the like) and/or software elements. For example, each of the elements of the outlier detector 500 may be embodied as any number, combination, configuration, and/or arrangement of logic gates, such as NOT (inverters), AND, OR, NOT AND (NAND), NOT OR (NOR), exclusive OR (XOR), exclusive NOR (XNOR), and/or other gates, some or all of which may be formed from combinations of various diodes, transistors, and/or other electrical elements. Additionally or alternatively, each of the elements of the outlier detector 500 may be embodied as any number, combination, configuration, and/or arrangement of comparator circuits, multiplexers, demultiplexers, encoders, decoders, tri-state buffers, sorting circuits, memory arrays, programmable logic arrays, arithmetic arrays, and/or the like, some or all of which may be formed from various combinations of logic gates. In other implementations, each of the elements of the outlier detector 500 may be embodied as any number, combination, configuration, and/or arrangement of software components that is/are executable by a general-purpose or special-purpose processor, such as any of those mentioned herein.

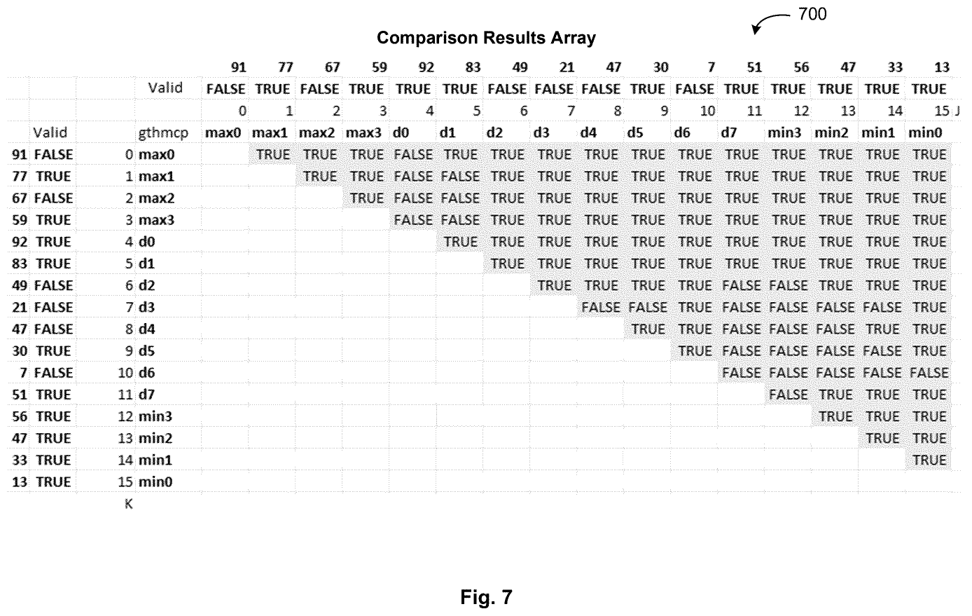

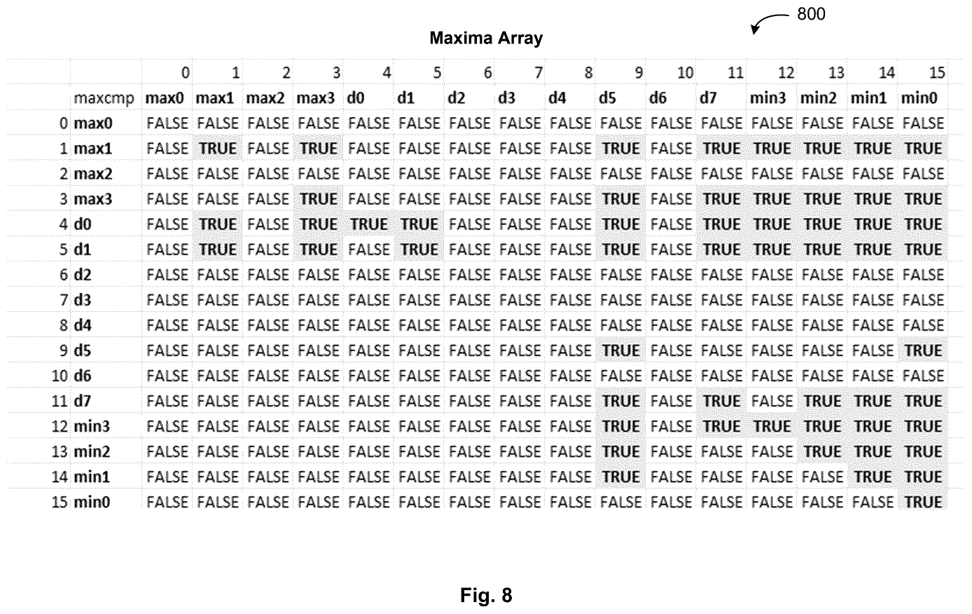

The comparator(s) 501 compare the data input 512 with a previous maxima 511 and a previous minima 513. The previous maxima 511 and previous minima 513 may be connected to the inputs of the comparator(s) 501 through one or more registers (not shown by FIG. 5). In some implementations, the data inputs 512 may be obtained from column readout circuitry 410; memories 416; and/or some other device or component, including any of those mentioned herein. The comparator(s) 501 may include any combination and arrangement of logic circuits and/or hardware elements depending on the specific comparison or logical operation to be performed. The comparator(s) 501 arrange the comparison results in such a way that the comparison results can be interpreted as one or more tables, matrices, or arrays, such as minima and maxima arrays. Example comparison results produced by the comparator(s) 501 are shown by table 700 in FIG. 7.

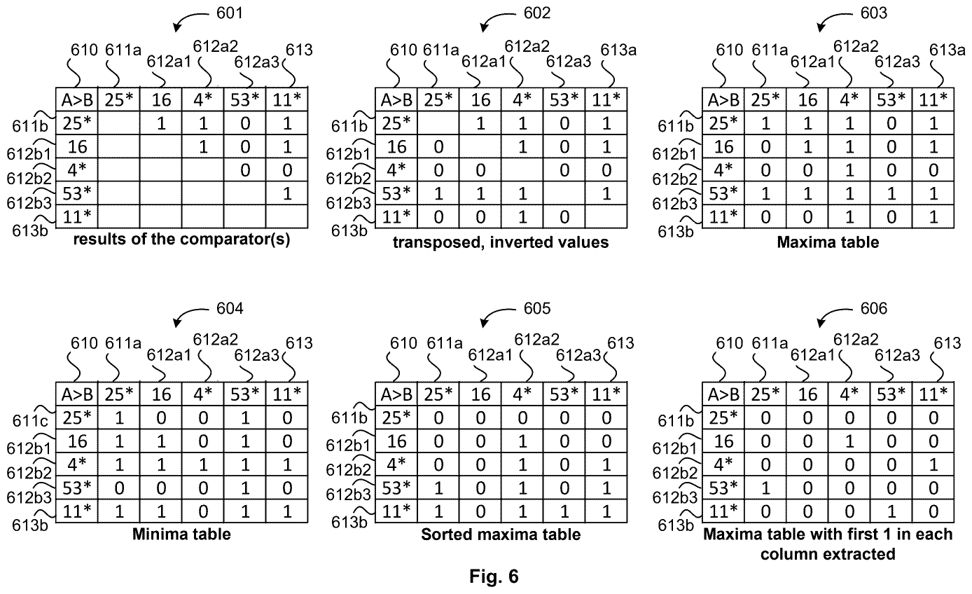

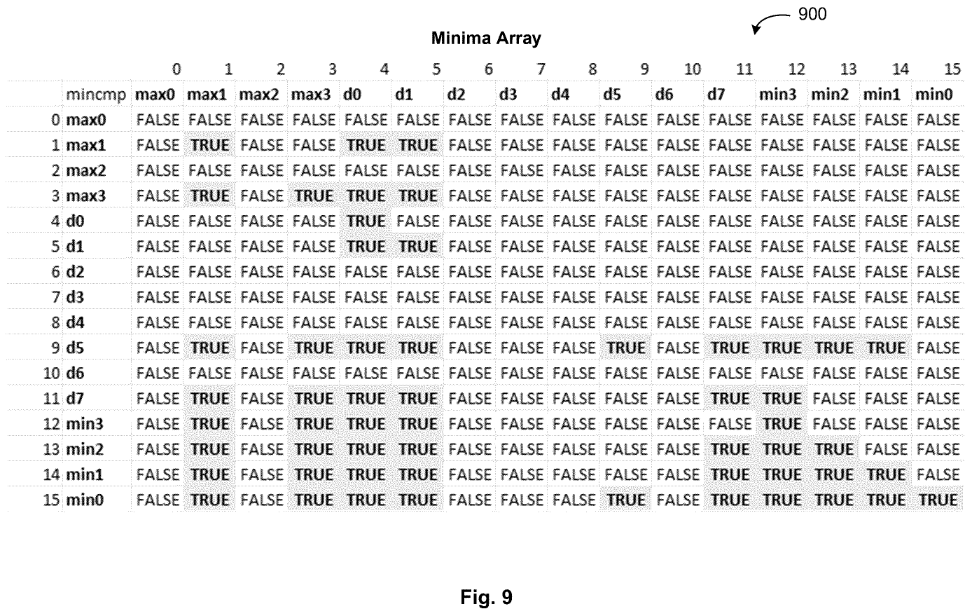

The maxima array forming element 502 arranges the comparison results from the comparator(s) 501 into a maxima array. An example of such a maxima array is shown by table 603 in FIG. 6 and table 800 in FIG. 8, which are discussed below. The maxima array forming element 502 and/or the minima array forming element 503 arranges the comparison results from the comparator(s) 501 into a minima array. An example of such a minima array is shown by table 604 in FIG. 6 and table 900 in FIG. 9, which is also discussed below.

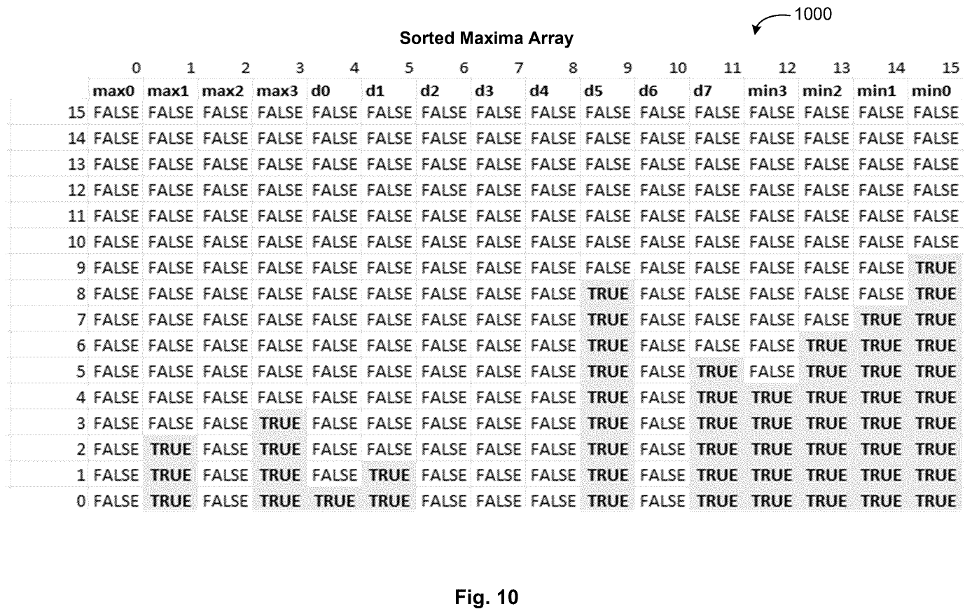

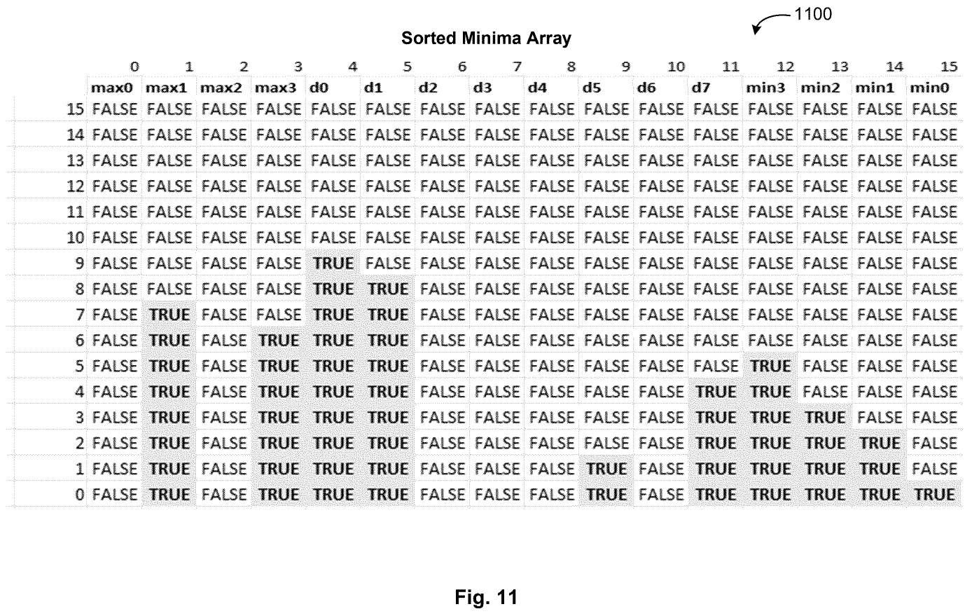

The maxima array sorting element 504A sorts the maxima array according to the qualifying (validity) signals 521, 522, 523 of each value. An example of a sorted maxima array is shown by table 1000 in FIG. 10, discussed below. The minima array sorting element 504B sorts the minima array according to the qualifying/validity signals 521, 522, 523 of each value. An example of a sorted minima array is shown by table 1100 in FIG. 11, discussed below.

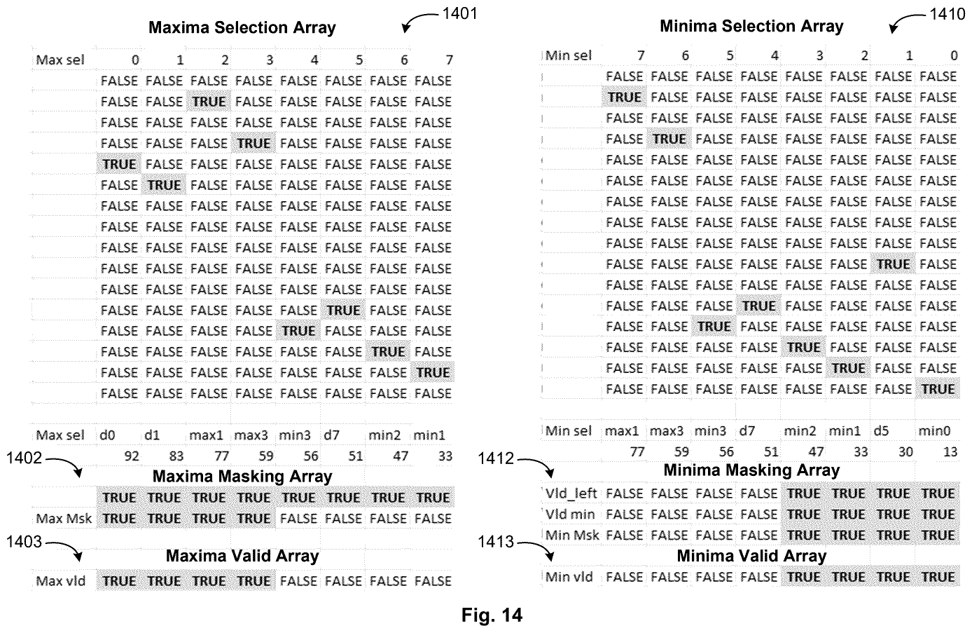

The valid array sorting element 504C sorts the qualifying (validity) signals 521, 522, 523 so that the qualifying (validity) signals can follow the data elements. For example, the maxima valid signal 541, data output valid signal 542, and minima valid signal 543 may be used for a next outlier detection iteration. The previous maxima valid signal 521, data valid signal 522, and previous minima valid signal 523 may be connected to the inputs of the sorter 504C through one or more registers (not shown by FIG. 5). The valid array sorting element 504C allows the filter 500 to function correctly if less than the number of minima/maxima elements are/were valid. The valid array sorting element 504C may sort the values to determine how many valid signals 541, 543 can be generated for the maxima and minima outputs 531, 533 and they need to be generated for the biggest and smallest of these elements. Additionally, the (re)aligning the values may also help avoid incorrectly indicating some elements as valid when such elements are actually invalid. An example of a sorted array of valid signals is shown by the top line of maxima masking table 1402 in FIG. 14. In some implementations, the valid array sorting element 504C includes selection logic to select and mark elements as valid or invalid. In other implementations, a separate selection element may be included after the valid array sorting element 504C for (in)valid element selection.

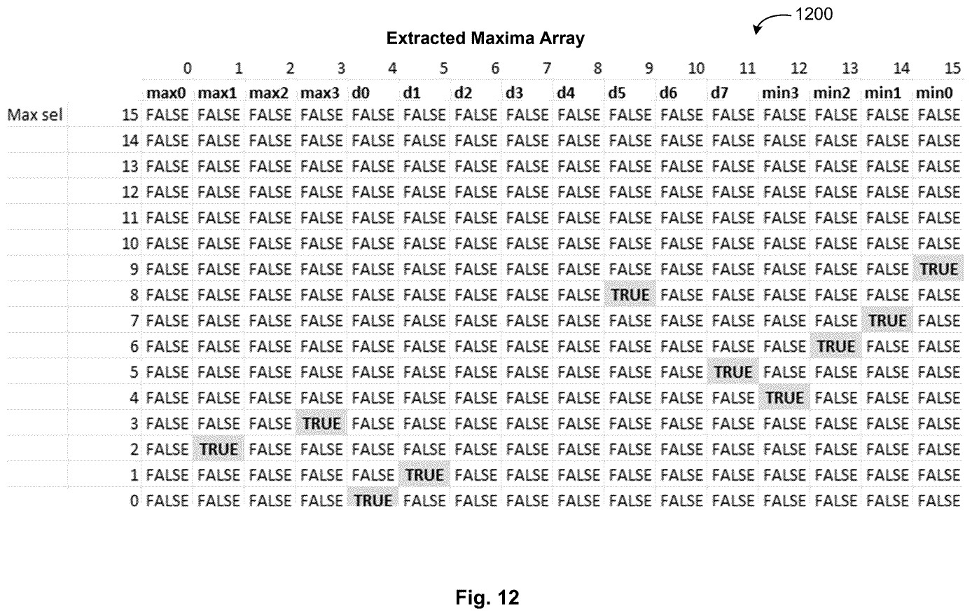

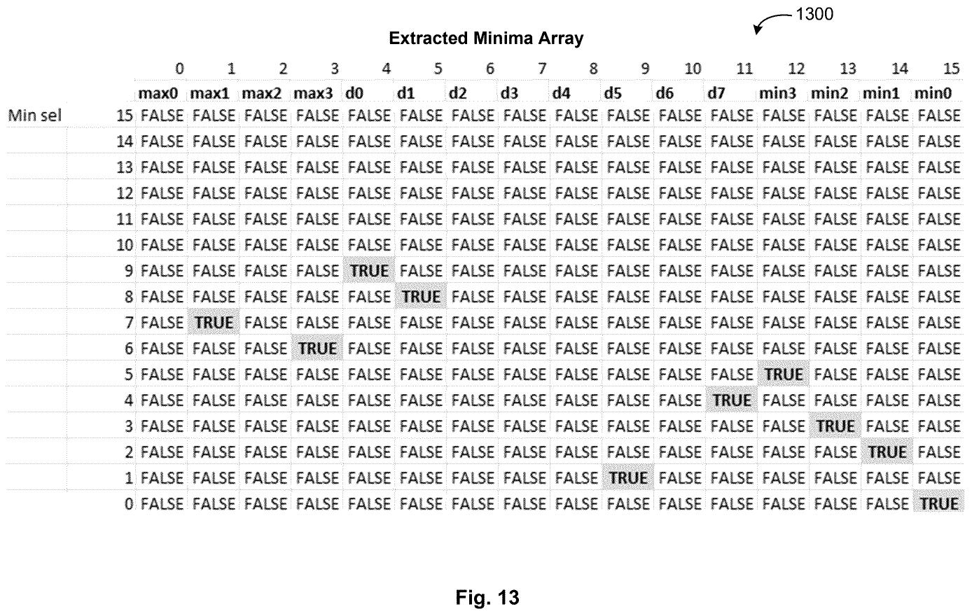

The maxima extractor and selector 505A extracts the maximum values from the sorted maxima array and selects the maximum values to be assigned to the maxima output 531. An example of such extraction and selection is shown by FIGS. 12 and 14. The minima extractor and selector 505B extracts the minimum values from the sorted minima array and selects the minimum values to be assigned to the minima output 533. An example of such extraction and selection is shown by FIGS. 13 and 14. FIGS. 12-14 are discussed below.

The filter 500 has N m-bit data elements as data inputs 512 (where N and m are integers). The filter 500 also makes use of the previous J m-bit minima elements 513 and the previous K m-bit maxima elements 511 (where J and K are integers). In some implementations, the previous J minima elements 513 and the previous K maxima elements 511 are each the same size and/or magnitude as the input data elements 512, or equal to N. In other implementations, a sum or combination of the previous J minima elements 513 and the previous K maxima elements 511 is/are the same size and/or magnitude as the input data elements 512. For example, where the input data 512 includes 8 elements, J and K may equal 4. In other implementations, the previous J minima elements 513 and the previous K maxima elements 511 are independent of N.

Along with the input signals 511, 512, 513, there are also K 1-bit qualifying signals 521 indicating the validity of the K maxima elements (also referred to as “previous maxima valid signals 521”), N 1-bit qualifying signals 522 (also referred to as “data valid signals 522”) to indicate whether the data elements of the data input 512 is/are valid, and J 1-bit qualifying signals 523 indicating the validity of the J minima elements 513 (also referred to as “previous minima valid signals 521”). In some implementations, a qualifying signal 521, 522, 523 having a value of ‘1’ indicates that the corresponding element is valid and a value of ‘0’ indicates that the corresponding element is invalid. The qualifying signals 521, 522, 523 may be passed along with their corresponding signals 511, 512, 513 as a separate indicator or flag for each data element indicating whether its corresponding element is valid or not valid.

The filter 500 outputs the values of the K largest data element (e.g., maxima output 531) and the J smallest data element (e.g., minima output 533) that are input. The filter 500 also outputs corresponding qualifying signals (e.g., maxima valid 541 and minima valid 543) to indicate whether each element is valid. The N data elements are passed through the filter 500 without modification as data output 532, as are the corresponding qualifying signals 542 for the data elements.

During the initial presentation of data elements, the values of the minima element 513 and maxima element 511 do not matter. The qualifying signal(s) 523 and qualifying signal(s) 521 indicate whether the minima element 513 and maxima element 511 are invalid, respectively. Upon the initial presentation of data elements of the previous maxima element 511, previous minima 513, and data input 512 are input into an array of comparator(s) 501. The array of comparator(s) 501 is configured such that no comparison of elements is repeated. This is achieved by selecting an initial element and then comparing it against every other element. A new element is then selected, which is then compared against every other element that has not been selected and/or compared yet. This process of selecting and comparing elements is repeated until every element has been selected and compared, and the last element will have no other elements to compare against.

In this example, the output of the comparator(s) 501 are stored in two 2-dimensional 1-bit arrays, such as maxima array and minima array produced by maxima array forming element 502 and minima array forming element 503, respectively. It should be understood that the output of the comparator(s) 501 can be stored in any number of arrays, where such arrays may have the same or different dimensions depending on implementation or design choice. The maxima array stores the results from the comparator(s) 501 to extract the maxima, and the minima array stores the results from the comparator(s) 501 to extract the minima. Each maxima and minima array is N+J+K elements in each dimension, and each column and row index corresponds to one of the input data elements of input data 512, the previous minima elements 513, or the previous maxima elements 511. This is symmetrical such that the same index across each dimension of the array corresponds to the same element. This association may be the same for every array that is created, and all arrays may have the same dimensions.

FIG. 6 shows example operations for forming a maxima array which is used to extract the maxima, and for the minima array which is used to extract the minima. In the example of FIG. 6, table element 610 shows the operation performed by the comparator(s) 501 (e.g., “A>B”). Table element 611a is a column index for the previous maxima value 511 and table element 611b is a row index for the previous maxima value 511. In this example, the previous maxima value 511 is “25”. Table elements 612a1, 612a2, and 612a3 are column indexes for respective data elements in data input 512, and table elements 612b1, 612b2, and 612b3 are row indexes for respective data elements in data input 512. In this example, the data elements are “16”, “4” and “53”. Table element 613a is a column index for the previous minima value 513 and table element 613b is a row index for the previous minima value 513. In this example, the previous minima value 513 is “11”. Additionally, the asterisk in each of the depicted tables indicates that its input is valid. Although the following discussion is related to operation of the maxima array, the same principles may be applicable to the operation of the minima array. For example, the minima array is shown by table 604. In this example, the minima array is the same as the maxima array, but transposed.

Table 601 represents a result of a first operation of using the results of the comparator(s) 501. Here, the maxima array is initially filled with the results from the comparator(s) 501 by using the selected element from the previous step as the index for the rows, and the element that the selected element is to be compared against as the column index. The value that is stored at this position is the result of the comparison of the two elements. This fills one corner of the array, as shown by table 601.

In the first operation, the value of each row index is compared with each value of each column index, in turn, and a resulting value is stored in a corresponding table element. In the depicted example, this operation may start at a top-left most table element and proceed along its row, then process the subsequent row's elements, and so forth until the bottom-right most table element has been processed. For example, the first operation may start at table element (611b, 611a) where a value of row index of row 611b (e.g., the maxima value 511 of “25”) is compared with the column index of column 611a (e.g., the maxima value 511 of “25”). The comparison operation for this table element (611b, 611a) may be skipped because it involves a comparison of a value with itself (e.g., a comparison of “25” with “25” in the depicted example). Therefore, table element (611b, 611a) is left unpopulated in table 601. The unpopulated cells in table 601 represent a comparison of an element with itself, or a comparison operation that has already been performed. Next, table element (611b, 612a1) is processed wherein the value of row index of row 611b (e.g., the maxima value 511 of “25”) is compared with the column index of column 612a1 (e.g., the first data element value of “16”), and a resulting value of the comparison is stored in table element (611b, 612a1). Here, the resulting value of “1” in table element (611b, 612a1) may represent “TRUE”, and table elements including a value of “0” may represent “FALSE”.

The other corner of the array is filled by repeating the previous operation, but switching the indexes between the rows and columns and inverting the value that is stored, as shown by table 602. Thus, table 602 represents a result of a second operation for forming the maxima array, wherein a transpose of table 601 is filled into table 602 with inverted values. For example, the maxima value 511 in column 611a (e.g., A=25) may be compared with the minima value 513 in row 613b (B=16), and a resulting value of the comparison is inverted and stored in the table element (613b, 611a). Thus, a value of “0” may be stored in table element (613b, 611a). Additionally or alternatively, table 601 (or the populated table elements in table 601) may be transposed such that table 601 is flipped over its diagonal and/or the row and column indices of table 601 are switched thereby producing another matrix, such as table 602. In either embodiment, this results in table 602 including a leading diagonal where the indices are equal, and therefore, the table elements of the leading diagonal remain unpopulated.

Table 603 represents a result of a third operation for forming the maxima array. Here, the leading diagonal of the maxima array where the indices are equal are filled with ones (“1”), as shown by table 603. Table 603 is the table for the maxima array.

Table 604 represents a resulting table for the minima array. As shown by table 604, the minima array is a transposed version of the maxima array 603. For example, the maxima array 603 may be flipped over its diagonal and/or the row and column indices of maxima array 603 may be switched to produce table 604. In other implementations, the minima array can be computed using the same or similar operations as discussed previously with respect to tables 601, 602, and 603.

Referring back to FIG. 5, after the maxima and minima arrays are generated, the maxima and minima arrays are sorted by sorting elements 504A, 504B, respectively. In some embodiments, the data in each column of each array is sorted and filtered. This may involve creating two new arrays, one for the minima and one for the maxima, in which to store the sorted data.

Sorting the maxima array may involve iterating over the columns or processing each column in the array individually. If the element corresponding to the column index is invalid, that column is skipped and the column is filled in the corresponding sorted array with zeros (“0”). If the element corresponding to the column index is valid, each row is iterated over, and if the element corresponding to the row index is valid and the cell value is one (“1”) at the row and column index, then the lowest unfilled row in the column is filled in the results array with a one (“1”). After each column has been considered, the result should be a sorted array. Table 605 in FIG. 6 is an example of the sorted maxima array based on the maxima array 603.

As an example, in table 603 of FIG. 6, column 612a1 corresponds to an invalid column index, and thus, each cell in column 612a1 of sorted results array 605 is populated with a zero (“0”). In another example, in table 603 of FIG. 6, row 611b corresponds to a valid row index, column 611a corresponds to a valid column index, and table element (611b, 611a) contains a value of one (“1”). The lowest unfilled row in the corresponding valid column 611a is row 613b. Therefore, table element (613b, 611a) is filled in the results array 605 with a one (“1”). Additionally, the table element (611b, 611a) is populated with a zero (“0”) in results array 605.

By way of another example, in table 603 of FIG. 6, row 611b corresponds to a valid row index, column 613a corresponds to a valid column index, and table element (611b, 613a) contains a value of one (“1”). The lowest unfilled row in the corresponding valid column 613a is row 612b2. Therefore, table element (612b2, 613a) is filled in the results array 605 with a one (“1”). Additionally, the table element (611b, 613a) is populated with a zero (“0”) in results array 605.

By way of yet another example, in table 603 of FIG. 6, row 612b3 corresponds to a valid row index, column 612a3 corresponds to a valid column index, and table element (612b3, 612a3) contains a value of one (“1”). The lowest unfilled row in the corresponding valid column 612a3 is row 613b. Therefore, in the results array 605, table element (613b, 612a3) is filled with a one (“1”) and table element (612b3, 612a3) is populated with a zero (“0”).

After sorting the arrays, the first one (“1”) is extracted from each column of the sorted arrays. To do this, each column is treated as a binary number where the most-significant bit (MSB) is a bit in the top-most row and the least-significant bit (LSB) is a bit in the bottom-most row. This binary number may be denoted as “X”. The extraction process includes right shifting X by 1 bit (insert a 0), inverting the right shifted X, and performing a bitwise AND operation on X and the inverted right-shifted X.

A bitwise AND operation is performed on X and the result of X right shifted by 1 bit then inverted. An example of such an operation is shown by equation 1, wherein in this example X=00000111, “&” is a bitwise AND operator, “˜” is a bitwise NOT (inversion) operator, and “>>” is a right shift operator.

$$00000111 \& ∼ ( 00000111 >> 1 ) = 00000111 \& ∼ 00000011 = 00000111 \& 11111100 = 00000100 \qquad ( 1 )$$

The result of this calculation is then mapped back into the array following the same mapping where the MSB is the top-most row and the LSB is the bottom-most row. An example of a sorted array with extracted is is shown by table 606 in FIG. 6. As shown by table 606, the first one (1) in each column of table 605 (i.e., the most significant cell with a one (1)) is maintained and the remaining ones (1) are replaced with zeros (0). This table 606 can now be used to extract the maximum values. The aforementioned process may be repeated for the sorted minima array 504B to extract the minima values.

To extract the minima 533 and maxima 531 from the minima array and maxima array, respectively, the final J rows are read from the final minima array and the final K rows are read from the final maxima array. The column that the one (1) appears in each row corresponds to the element that is the Jth minima or Kth maxima. The last row is the smallest/largest and each row higher contains the next ranked minima/maxima. For example, as shown by table 606 in FIG. 6, column 612a3 has a lowest row 613b with a one (“1”), which means that the column index corresponding to column 612a3 (“53” in this example) is the largest value. Additionally, column 611a in table 606 has a next lowest row 612b3 with a one (“1”), which means that the column index corresponding to column 611a (“25” in this example) is the next largest value. In some cases, a row can be all zeros in which case the selected value does not matter since it will be marked invalid by the valid array sorting logic 504C. For example, in table 606, row 611b may be marked as invalid.

The valid qualifiers for each of the minima and maxima elements are generated by sorting the valid qualifiers from the input data (e.g., data valid signal 522) and the valid qualifiers for all the previous minima and maxima elements (e.g., previous minima valid signal 523 and previous maxima valid signal 521). This is done using the same technique that was used for sorting each column within the tables as discussed previously with respect to FIG. 6. Thus, the valid qualifiers 521, 522, 523 are arranged into a sorted valid array by the valid array sorting logic 504C. By sorting the valid qualifiers 521, 522, 523, it is possible to select an equal number of minima and maxima by using the even values for one and the odd values for the other. If an inequal number of minima and maxima are required or preferred, it is possible to select different numbers of each by prioritising either the minima or maxima and selecting the valid signals from the sorted valid signals and then sorting, or otherwise selecting from, the valid signals that were unused. The newly sorted valid signals can then be used to qualify the remaining minima/maxima values.

For example, with four (4) minima values, four (4) maxima values, and eight (8) input values, valid qualifiers of 0001 (max) 1001 1010 (data) 0011 (min) may be sorted to: 0000 0000 0111 1111. Selecting the even indexed values for the minima would result in four (4) valid minima and the odd indexed values result in three (3) valid maxima.

The arrangement shown by FIG. 5 may be advantageous in many ways. One advantage is that the outlier detector 500 uses considerably fewer comparators than previous outlier detection designs used in existing image sensors. Another advantage is that the outlier detector 500 can be implemented entirely using combinational logic, which allows the values to be extracted without pipelining the data values. This saves on both power and circuit area which are important factors in designing low footprint devices, such as image sensors and the like.

### 3. Example Outlier Detection Scenario

As noted above, various applications and/or scenarios may benefit from outlier values being identified and/or removed from a data set, such as dataset 111 in FIG. 1. One example outlier detection application/scenario may involve a data input comprising a set of pixel values that is processed as part of a noise reduction algorithm. The noise reduction algorithm may be a computational technique used to enhance the quality of images, audio, communication signals, and/or other data by removing unwanted random variations or “noise” that obscures the desired signal. Noise reduction algorithms identify and suppress noise while preserving as much of the original information as possible. In this example scenario, the noise to be reduced by such a noise reduction algorithm may be in the form of outlier pixel values that are removed from the set of pixel values for further processing. Example use cases for such noise reduction algorithms include digital photography, medical imaging, astronomy, surveillance systems, biometric processing, satellite imagery, video processing which may be used for object recognition and/or computer vision applications, industrial inspection processes, robotics and autonomous vehicles, and the like.

In one example, an image array comprising the set of pixel values can be generated based on an already captured image or as an image is captured in real-time (or near real-time). As the image is captured by an imaging sensor, such as imaging system 200, the maximum and minimum pixel values of the image array may be pulled out of the image array in real time (or in near real-time). These values may be discarded and/or passed on to another system or process for further processing and/or for other purposes. One goal is to remove the outliers as quickly as possible so as to avoid storing the pixel data prior to pre-processing or processing in order to conserve memory and computational resources. In this example, the imaging sensor may generate and stream a set of eight pixel values simultaneously, some of which may or may not be valid due to the way that they are read out. The four largest and the four smallest pixel values, or up to the four biggest and up to the four smallest pixel values, may be removed from that data stream for further statistical analysis. The outlier detection of this example scenario may be performed by the ODC 102 as described in more detail with respect to FIGS. 7 to 14.

FIG. 7 shows an example comparison results table 700, which may be formed by the comparator(s) 501 in FIG. 5. In this example, the comparator(s) 501 perform a greater than (“>”) comparison operation. Table 700 includes the following set of inputs: the four previous maxima 511 including maxima 0 (“max0”) in row 0 and column 0, maxima 1 (“max1”) in row 1 and column 1, maxima 2 (“max2”) in row 2 and column 2, and maxima 3 (“max3”) in row 3 and column 3; the four previous minima 513 including minima 0 (“min0”) in row 15 and column 15, minima 1 (“min1”) in row 14 and column 14, minima 2 (“min2”) in row 13 and column 13, and minima 3 (“min3”) in row 12 and column 12; and eight data inputs 512 including data input 0 (“d0”) in row 4 and column 4, data input 1 (“d1”) in row 5 and column 5, data input 2 (“d2”) in row 6 and column 6, data input 3 (“d3”) in row 7 and column 7, data input 4 (“d4”) in row 8 and column 8, data input 5 (“d5”) in row 9 and column 9, data input 6 (“d6”) in row 10 and column 10, and data input 7 (“d7”) in row 11 and column 11. In this example, max0 has a value of 91, max1 has a value of 77, max2 has a value of 67, max3 has a value of 59, d0 has a value of 92, d1 has a value of 83, d2 has a value of 49, d3 has a value of 21, d4 has a value of 47, d5 has a value of 30, d6 has a value of 7, d7 has a value of 51, min3 has a value of 56, min2 has a value of 47, min1 has a value of 33, and min0 has a value of 13. Each input also has a corresponding valid signal/indicator 521, 522, 523. In this example, the valid signal for max0 is “FALSE” indicating that the max0 value is not valid; the valid signal for max1 is “TRUE” indicating that the max1 value is valid; and so forth.

The comparison results are populated in each cell of the table 700 by comparing the value of the row index of that row with the value of the column index of each column starting at cell (0,0) and moving sequentially to cell (0,15). Each row is processed sequentially from row 0 to row 15. The comparison operation is skipped if the row index is compared with an identical column index or if the operation has already been performed. The cells where the comparison is skipped are left blank. In this example, the table 700 is processed starting at cell (0,0) where the comparison of max0 with max0 is skipped, and thus, cell (0,0) is left blank. Next, cell (0,1) is processed where the value of max0 (91) is compared with the value of max1 (77). A value of “TURE” is stored in cell (0,1) because 91 is greater than 71. Next, cell (0,2) to cell (0,15) are processed in a similar fashion, and the result of each comparison operation is stored in a corresponding cell. After row 0 is processed, row 1 is processed in a similar manner starting at cell (1,0) and ending at cell (1,15). Note that the comparison operation for cell (1,0) is skipped because a comparison of max1 and max0 has already been performed (e.g., at cell (0,1)), and the comparison operation for cell (1,1) is skipped because it would involve comparing identical row and column indexes (i.e., comparing max1 with max1).

FIG. 8 shows an example of a maxima array 800 (or “maxima table 800”) based on the comparison results 700. The maxima array 800 may be produced by the maxima table forming element 502 in FIG. 5. In this example, the values in each row of table 700 are inverted and placed in corresponding columns in table 800. However, if a value is invalid, then the corresponding column in table 800 is populated with “FALSE” values. Additionally, each comparison of a value with itself is also automatically populated with a “TRUE” value unless that value is indicated as being invalid.

For example, column 0 (max0) in table 800 is populated with “FALSE” values because it is invalid as indicated by the valid indicator signal corresponding to max0 in table 700. The valid indicator signal corresponding to max1 in table 700 is indicated as being “TRUE”, and thus, the values in row 1 (max 1) in table 700 are inverted and inserted into column 1 (max1) in table 800. Here, cell (1,1) in table 800 holds a “TRUE” value because it involves a self-comparison (i.e., a comparison of max1 with max1). Additionally, cell (1,2) in table 700 holds a value of “TRUE”, and thus, cell (2,1) in table 800 holds its inverse (i.e., “FALSE”). In another example, cell (1,3) in table 700 holds a value of “TRUE”, and thus, cell (3,1) in table 800 holds a value of “FALSE”. In yet another example, cell (1,4) in table 700 holds a value of “FALSE”, and thus, cell (4,1) in table 800 holds a value of “TRUE”.

Furthermore, it should be noted that the relative magnitude of the data elements in table 800 can be identified or determined by counting the number of cells in a column with “TRUE” values, where the column with the fewest “TRUE” values have the greatest magnitude, the column with the most “TRUE” values has the smallest magnitude, and columns with zero “TRUE” values indicate invalid data elements. For example, the column in table 800 with a single cell having a “TRUE” value is column 4. The column index corresponding to column 4 is data element d0. As shown by FIG. 7, d0 has a value of 92, which is the largest number among all of the all of data element values shown by FIG. 7. By way of another example, column 5, whose column index is d1, includes two cells with a “TRUE” value. As shown by FIG. 7, d1 has a value of 91, which is the next largest value after 92. By way of yet another example, column 15 corresponds to data element min0 which has the smallest value of 13 (among the valid data elements), and as shown by FIG. 8, column 15 includes 10 cells with a “TRUE” value.

Similarly, the relative magnitude of the data elements in table 800 can be identified or determined by counting the number of cells in a row with “TRUE” values, where the row with the fewest “TRUE” values have the smallest magnitude, the column with the most “TRUE” values has the greatest magnitude, and columns with zero “TRUE” values indicate invalid data elements. For example, the row in table 800 with a single cell having a “TRUE” value is row 15, which corresponds to data element min0. As mentioned previously, min0 has the smallest magnitude among all of the data elements in the depicted example. By way of another example, row 4 includes 10 cells that have a “TRUE” value. Row 4 corresponds to data element d0, which has the largest value as mentioned previously.

FIG. 9 shows an example of a minima array 900 (or “minima table 900”), which is based on the comparison results 700 and/or the maxima array 800. The minima array 900 may be produced by the minima table forming element 503 in FIG. 5. In this example, the minima array 900 is a transpose of the maxima array 800. In other embodiments, the minima array 900 can be generated by inverting the values in each row of table 700 and placing those inverted values in corresponding rows in array 900. Similar to maxima array 800, if a value from table 700 is invalid, then the corresponding row in table 900 is populated with “FALSE” values. Additionally, each comparison of a value with itself is also automatically populated with a “TRUE” value unless that value is indicated as being invalid.

Similar to maxima array 800, the relative magnitude of the data elements in table 900 can be identified or determined by counting the number of cells in a column with “TRUE” values, where the column with the most “TRUE” values has the greatest magnitude, the column with the fewest “TRUE” values has the smallest magnitude, and columns with zero “TRUE” values indicate invalid data elements. For example, the column in table 900 with a single cell having a “TRUE” value is column 15, which as mentioned previously, corresponds to data element min0 that has the smallest value of 13. By way of another example, column 4, whose column index is d0, includes 10 cells with a “TRUE” value, and as mentioned previously, d0 has the largest value of 92.

Additionally, the relative magnitude of the data elements in table 800 can be identified or determined by counting the number of cells in a row with “TRUE” values, where the row with the most “TRUE” values has the smallest magnitude, the column with the fewest “TRUE” values has the greatest magnitude, and columns with zero “TRUE” values indicate invalid data elements. For example, row 15 in table 900 has the most cells with a “TRUE” value and corresponds to the data element min0 having the smallest value, and row 4 in table 900 has the fewest cells with a “TRUE” value and corresponds to the data element d0 having the greatest value.

FIG. 10 shows an example sorted maxima table 1000 and FIG. 11 shows an example sorted minima table 1100. The sorted maxima table 1000 may be produced by the maxima array sorting element 504A in FIG. 5, and the sorted minima table 1100 may be produced by the minima array sorting element 504B in FIG. 5. The sorting of the maxima array 800 and 900 is to arrange the columns such that the cells having “TRUE” values are lined up towards the bottom of the tables. And as discussed previously, the column in sorted maxima table 1000 having the fewest cells with a “TRUE” value represents the largest value and the column in sorted maxima table 1000 having the most cells with a “TRUE” value represents the smallest value. Similarly, the column in sorted minima table 1100 having the fewest cells with a “TRUE” value represents the smallest value and the column in sorted maxima table 1100 having the most cells with a “TRUE” value represents the largest value. It should also be noted that the number of true values in each column in each tables 800, 900, 1000, and 1100 is always unique.

FIG. 12 shows an example extracted maxima table 1200 and FIG. 13 shows an example extracted minima table 1300. The extracted maxima table 1200 may be produced by the extractor and selector 105A in FIG. 5, and the extracted minima table 1300 may be produced by the extractor and selector 505B in FIG. 5. In FIG. 12, the location of the first (or top most) true value is extracted in each column. For example, in table 1000 and table 1200, the top-most “TRUE” value for min0 is located at cell (9, 15), and thus, the “TRUE” value in cell (9,15) remains and the remaining cells in column 15 are converted to “FALSE” values. This may be done using suitable hardware elements, such as exclusive OR (XOR) gate(s). For example, each column in table 1000 can be treated as a binary number X, and binary number X can be right-shifted by 1 to produce a binary number Y. To obtain the resultant table 1200, X is XOR'd with Y (e.g., X⊕(Y), which masks off the top-most value.

The maxima 531 and the minima 533 can be identified and/or determined by reading the rows in table 1200. The largest (maximum) value corresponds to the column index whose “TRUE” value is positioned lowest (towards the bottom) in table 1200 and the smallest (minimum) value corresponds the column index whose “TRUE” value is positioned highest (towards the top) in table 1200. For example, in table 1200, column 4, corresponding to data element d4, has a cell with a “TRUE” value in row 0, which is the lowest position in which a “TRUE” value can be positioned in table 1200. And as such, d4 contains the largest value. Additionally, the second largest value corresponds to a column index whose “TRUE” value is the second lowest in table 1200 (e.g., d1 of column 5 in table 1200), the third largest value corresponds to a column index whose “TRUE” value is the third lowest in table 1200 (e.g., max1 of column 1 in table 1200), and so forth. By way of another example, the highest positioned “TRUE” value in table 1200 is located in column 15, corresponding to data element min0, whose “TRUE” value is located in row 9. And as such, min0 contains the smallest value.

In table 1300 of FIG. 13, the largest (maximum) value corresponds to a value of the column index whose “TRUE” value is positioned highest in table 1300 and the smallest (minimum) value corresponds to a value of the column index whose “TRUE” value is positioned lowest in table 1200. For example, the lowest positioned “TRUE” value is located in cell (0,15) in table 1300, which corresponds to min0. Therefore, min0 corresponds to the smallest value in the dataset. Additionally, the second smallest value corresponds to a column index whose “TRUE” value is the second lowest in table 1300 (e.g., d5 of column 9 in table 1300), the third smallest value corresponds to a column index whose “TRUE” value is the third lowest in table 1300 (e.g., min1 of column 14 in table 1300), and so forth. By way of another example, the highest positioned “TRUE” value is located in cell (9,4) in table 1300, which corresponds to d0 and a value of d0 corresponds to the maxima 531.

After the largest and smallest values are identified in table 1200 and/or table 1300, the maxima 531 and the minima 533 can be selected as shown by FIG. 14.

FIG. 14 shows an example maxima selection table 1401 for selecting the maxima 531 when not all of the values are valid and an example minima selection table 1410 for selecting the minima 533 when not all of the values are valid. The maxima selection table 1401 may be produced by the extractor and selector 105A in FIG. 5, and the minima selection table 1410 may be produced by the extractor and selector 505B in FIG. 5.

Maxima selection table 1401 may be produced by sorting the valid values from table 1200 of FIG. 12, such that all of the valid elements are placed on one side of the table 1401 as shown (note that the invalid values are not shown in FIG. 14). The eight largest valid values are arranged in columns 0 to 7 in table 1401. Then, the values for the maxima 531 are selected according to the specific implementation or use-case that is predefined or configured. In the example scenario described previously, the largest four maximum values (e.g., data elements d0, d1, max1, max3) are to be assigned to the maxima 531, and therefore, the next four maximum values (e.g., data elements min3, d7, min2, min1) are masked out as shown by maxima masking table 1402. This results in maxima valid table 1403, showing the four data elements with the largest values (e.g., data elements d0, d1, max1, max3) being assigned to the maxima 531. The maxima valid table 1403 may represent a final output resulting from the sorting that took place as shown in the maxima masking table 1402.

In some implementations, the remaining four elements in maxima selection table 1401 (e.g., data elements d0, d1, max1, max3) may be the next four largest elements, or may be assigned to the minima 533. The position of the smallest values varies depending on the number of valid inputs. For example, if the maxima selection table 1401 were extended for all 16 inputs, then the remaining four elements in maxima selection table 1401 (e.g., data elements d0, d1, max1, max3) may be the smallest values. Although it is possible to extract the minimum values from the maxima selection table 1401, in some implementations, extracting the minimum values may be easier by using a separate table, such as minima selection table 1410.

In this example scenario, the minima 533 may be selected using minima selection table 1410. Minima selection table 1410 may be produced by sorting the valid values from table 1300 of FIG. 13, such that all of the valid elements are placed on one side of the table 1410 as shown (note that the invalid values are not shown in FIG. 14). The eight smallest valid values are arranged in columns 7 to 0 in table 1410. Then, the values for the minima 533 are selected according to the specific implementation or use-case that is predefined or configured. In the example scenario described previously, the smallest four minimum values (e.g., data elements min2, min1, d5, min0) are to be assigned to the minima 533, and therefore, the next four minimum values (e.g., data elements max1, max3, min3, d7) are masked out as shown by minima masking table 1412. The “Vld_min” row in the minima masking table 1412 resorts the valid signals left after a “Max_msk” function (see e.g., Max_msk row in maxima masking table 1402) is applied because the remaining valid signals may not be aligned correctly. In some embodiments, this step may be included based on the specific implementation of how the selection between minima and maxima outputs is to take place. In other embodiments, this step may be skipped. This results in minima valid table 1413, showing the four data elements with the smallest values (e.g., data elements min2, min1, d5, min0) being assigned to the minima 533. The minima valid table 1413 may represent a final output resulting from the sorting that took place as shown in the minima masking table 1412.

The example embodiments discussed herein may be used to split the valid signals, such as valid signals 541, 542, and 543, for determining the priority of selecting minima 533 and/or maxima 531 when a certain number (less than eight in this example) of the inputs are valid. For example, if three inputs are valid for a first cycle/iteration, then either (i) all valid signals can be used for the maxima 531 and all of the inputs can be used as the maxima 531, or (ii) every even valid signal can be used for the maxima 531 and odd valid signal can be used for the minima 533. In this example, two of the values may be classified as the maxima 531 and one value may be classified as the minima 533.

In some implementations, the number of values to be selected for the maxima 531 and minima 533 may be scaled up or down, depending on the specific use case or design choice. For example, some implementations may involve selecting one, two, or three values for each of the maxima 531 and minima 533, while in other implementations, more than four values may be selected for each of the maxima 531 and minima 533. However, the number of pixel values to be selected for the maxima 531 and minima 533 may be limited based on the clock rate of the system and/or other constraints. It should also be noted that the number of values selected for the maxima 531 may be different than the number of values selected for the minima 533. For example, four values may be selected for the maxima 531 and two values selected for the minima 533, or vice versa. In some implementations, the number of values selected for the maxima 531 and minima 533 can be dynamically selected based on the statistical analysis being calculated, such as when a calculated average has deviated from some error or standard deviation. Additionally or alternatively, the specific data elements or values selected for the maxima 531 and minima 533 may be based on weightings or other parameters or conditions predefined or configured for downstream processing

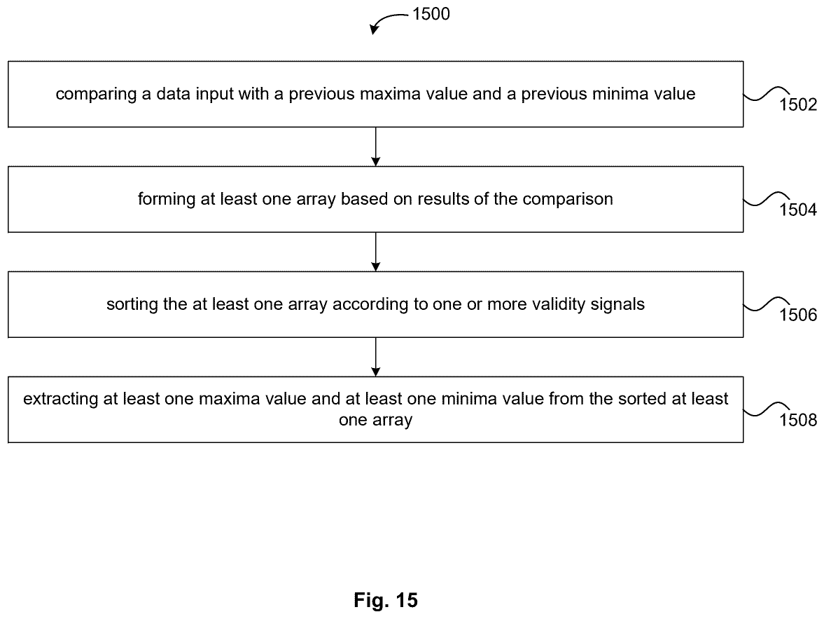

FIG. 15 illustrates a method 1500 for performing outlier detection, which may be performed by outlier detection circuitry, such as ODC 102 and/or the outlier detector 500 discussed previously. The method begins at operation 1502 where the outlier detection circuitry compares a data input, such as data input 512, with a previous maxima value and a previous minima value, such as previous maxima 511 and previous minima 513. At operation 1504, the outlier detection circuitry forms at least one array, such as a maxima array and/or minima array discussed previously, based on results of the comparison. At operation 1506, the outlier detection circuitry sorts the at least one array according to one or more validity signals, such as the previous maxima valid signal 521, the data valid signal 522, and/or previous minima valid signal 523. At operation 1508, the outlier detection circuitry extracts and/or selects at least one maxima value and at least one minima value, such as maxima output 531 and minima output 533, from the sorted at least one array.

### 4. Further Remarks

For the purposes of the present disclosure, the singular forms “a,” “an” and “the” are intended to include plural forms as well, unless the context clearly indicates otherwise. The terms “comprises” and/or “comprising,” when used herein, specify the presence of stated features, integers, steps, operations, elements, and/or components, but do not preclude the presence or addition of one or more other features, integers, steps, operations, elements, components, and/or groups and/or combinations thereof. Additionally, the phrase “A and/or B” means (A), (B), or (A and B), and the phrase “A, B, and/or C” means (A), (B), (C), (A and B), (A and C), (B and C), or (A, B and C). The phrase “X(s)” means one or more X, a set of X, or a plurality of X. As used herein, the term “each” refers to each member of a set or each member of a subset of a set. The phrases “in an embodiment,” “In some embodiments,” “in one implementation,” “In some implementations,” “in some examples”, and other similar phrases used herein may refer to one or more of the same or different embodiments, implementations, and/or examples. Furthermore, the terms “comprising,” “including,” “having,” and the like, as used with respect to the present.

Moreover, reference to “one or more processors” herein includes situations where a set of processors may be configured to perform one or more operations. Any combination of such a set of processors may perform individual operations or a group of operations. This may include two or more GPUs, CPUs, TPUs, ASICs, FPGAs or DSPs (or other hardware-based processing elements) or any combination thereof. It may also include situations where the processors have multiple processing cores. Therefore, reference to “one or more” such devices do not require that all processing elements (or cores) in the set must each perform all of the operations. Rather, unless expressly stated, any one of the one or more processing elements (or cores) may perform different operations when a set of operations is indicated, and different processing elements (or cores) may perform specific operations, either sequentially or in parallel.

Unless otherwise specifically noted, articles depicted in the drawings are not necessarily drawn to scale. In the appended drawings, which are not necessarily drawn to scale, like numerals may describe similar components in different views. Like numerals having different letter suffixes may represent different instances of similar components.

Although the technology herein has been described with reference to particular embodiments/configurations, it is to be understood that these are merely illustrative of the principles and applications of the present technology. It is therefore to be understood that numerous modifications may be made to the illustrative embodiments and that other arrangements may be devised without departing from the spirit and scope of the present technology as defined by the appended claims. By way of example only, components that are illustrated as being arranged in series may have a complementary configuration in parallel; similarly, components that are illustrated as being arranged in parallel may have a complementary configuration in series.

1. A method of performing outlier detection, the method comprising:
comparing, by outlier detection circuitry, a data input with a previous maxima value and a previous minima value of a previous data input;
forming, by the outlier detection circuitry based on results of the comparing, at least one array;
sorting, by the outlier detection circuitry, the at least one array based on one or more validity signals associated with the data input, the previous maxima value, and the previous minima value; and
extracting, by the outlier detection circuitry, at least one maxima value and at least one minima value from the sorted at least one array.

2. The method of claim 1, wherein the at least one array comprises a maxima array, and the forming comprises:
forming a first portion of the maxima array using the results of the comparing; and
forming a second portion of the maxima array based on a transpose of the first portion.

3. The method of claim 2, wherein the maxima array is a two dimensional array, and the forming further comprises:
forming the first portion such that a number of stored elements progressively decreases with each subsequent row in the maxima array; and
forming the second portion such that a number of stored elements progressively increases with each successive row in the maxima array.

4. The method of claim 2, wherein the forming further comprises:
storing a predefined value in a leading diagonal of elements in the maxima array.

5. The method of claim 2, wherein the at least one array further comprises a minima array, and the forming further comprises:
forming the minima array by transposing the maxima array.

6. The method of claim 1, wherein each column in the at least one array corresponds to a respective data element in a set of data elements, and the set of data elements includes at least one data element from the data input, at least one data element from the previous maxima value, and at least one data element from the previous minima value.

7. The method of claim 6, wherein the comparing comprises:
comparing an initial data element from the set of data elements against every other data element in the set of data elements; and
comparing each other data element in the set of data elements against every other data element in the set of data elements that has not been selected or compared until all data elements in the set of data elements have been compared.

8. The method of claim 6, wherein each row in the at least one array corresponds to a respective data element in the set of data elements, and the sorting comprises:
identifying, according to the one or more validity signals, valid data elements in the set of data elements and invalid data elements in the set of data elements;
populating each cell in each column corresponding to an invalid data element with a first value; and
iterating over each row in each column corresponding to a valid data element.

9. The method of claim 8, wherein the iterating over each row in each column corresponding to a valid data element comprises:
for each row corresponding to a valid data element, identifying each array element in each column corresponding to a valid data element that is equal to a second value;
for each identified array element, populating a lowest array element in each row storing the first value with the second value; and
for each column corresponding to a valid data element,
performing a binary right shift operation on a column value, wherein the column value is a binary number defined by each element in the column;
inverting the right shifted column value; and
performing a binary AND operation on the column value and the inverted column value.

10. The method of claim 9, wherein the extracting further comprises:
determining, as the at least one maxima value, a data value corresponding to a column with a lowest row in the at least one array storing the second value; and
determining, as the at least one minima value, a data value corresponding to a column with a highest row in the at least one array storing the second value.

11. An outlier detection circuit, comprising:
comparator circuitry configured to compare a data input with a previous maxima value and a previous minima value of a previous data input;
array forming circuitry configured to form at least one array based on results of the comparing;
array sorting circuitry configured to sort the at least one array according to one or more validity signals; and
extractor circuitry configured to extract at least one maxima value and at least one minimum value from the sorted at least one array.

12. The outlier detection circuit of claim 11, wherein the at least one array comprises a maxima array, and the array forming circuitry is configured to:
form a first portion of the maxima array using the results of the comparing; and
form a second portion of the maxima array based on a transpose of the first portion.

13. The outlier detection circuit of claim 12, wherein the maxima array is a two dimensional array, and the array forming circuitry is configured to:
form the first portion such that a number of stored elements progressively decreases with each subsequent row in the maxima array; and
form the second portion such that a number of stored elements progressively increases with each successive row in the maxima array.

14. The outlier detection circuit of claim 12, wherein the array forming circuitry is configured to:
store a predefined value in a leading diagonal of elements in the maxima array.

15. The outlier detection circuit of claim 12, wherein the at least one array further comprises a minima array, and the array forming circuitry is configured to:
form the minima array by transposing the maxima array.

16. The outlier detection circuit of claim 11, wherein each column in the at least one array corresponds to a respective data element in a set of data elements, and the set of data elements includes at least one data element from the data input, at least one data element from the previous maxima value, and at least one data element from the previous minima value.

17. The outlier detection circuit of claim 16, wherein the comparator circuitry is configured to:
compare an initial data element from the set of data elements against every other data element in the set of data elements; and
compare each other data element in the set of data elements against every other data element in the set of data elements that has not been selected or compared until all data elements in the set of data elements have been compared.

18. The outlier detection circuit of claim 16, wherein each row in the at least one array corresponds to a respective data element in the set of data elements, and the array sorting circuitry is configured to:
identify, according to the one or more validity signals, valid data elements in the set of data elements and invalid data elements in the set of data elements;
populate each cell in each column corresponding to an invalid data element with a first value; and
iterate over each row in each column corresponding to a valid data element.

19. The outlier detection circuit of claim 18, wherein, to iterate over each row in each column corresponding to a valid data element, the array sorting circuitry is configured to:
for each row corresponding to a valid data element, identify each array element in each column corresponding to a valid data element that is equal to a second value;
for each identified array element, populate a lowest array element in each row storing the first value with the second value; and
for each column corresponding to a valid data element,
perform a binary right shift operation on a column value, wherein the column value is a binary number defined by each element in the column;
invert the right shifted column value; and
perform a binary AND operation on the column value and the inverted column value.

20. The outlier detection circuit of claim 19, wherein the extractor circuitry is configured to:
determine, as the at least one maxima value, a data value corresponding to a column with a lowest row in the at least one array storing the second value; and
determine, as at least one minima value, a data value corresponding to a column with a highest row in the at least one array storing the second value.
